(19) United States
(12) Patent Application Publication
(10) Pub. No.: US 2024/0369129 A1
(43) Pub. Date: Nov. 7, 2024

(54) CVT WITH IDLE AND REVERSE FUNCTION

(71) Applicant: Karl Zetterlund, Houston, TX (US)

(72) Inventor: Karl Zetterlund, Houston, TX (US)

(21) Appl. No.: 18/445,153

(22) Filed: May 3, 2023

(51) Int. Cl. F16H 37/12

(52) U.S. Cl. CPC F16H 37/12

(57) ABSTRACT

A continuous variable transmission, Variator, which works on the ball and disc principle whereby the ball is in a fixed position, free to rotate in any direction, and the discs move to and from each other causing output shaft to either idle or rotate of various speeds including reverse as directed by the attached control device, without need for additional gears and clutches.

### DESCRIPTION

Drawing #1 is a general overview of the invention.

Drawing #2 is a general overview with parts identified by numbers.

Drawing #3 indicates gear ratios for different positions of swing arms relative to the ball.

Drawing #4 show the invention with only one swing arm.

Ref. Drawing #2

### PART SPECIFICATION

1 Ball
2 Rotating disc, power input
3 Rotating disc, power output
4 Shaft, power input
5 Shaft, power output
6 Gear wheel, power input
7 Gear wheel, Power output
8 Gear wheel connected to rotating disc, power input
9 Gear wheel connected to rotating disc, power output
10 Swing arm, power input
11 Swing arm, power output
12 Gear wheel for position adjustment swing arm, power input
13 Gear wheel for position adjustment swing arm, power output
14 Gear wheel for position adjustment both swing arms simultaneously
15 Gear wheels, one each side of the control wheel (14) for positioning Swing arms
16 Device for control of pressure between disc (3) and ball (1)
17 Device for control of pressure between disc (2) and ball (1)

### FUNCTION

A ball (1) is inserted in a bearing assembly where it can rotate in any direction as controlled by two rotating discs. On each side of the ball are disc (2) and (3) located. Each disc are covered with high friction material on the side touching the ball. Each disc is connected to a gear wheel (8) and (9) via a shaft and which shafts are freely rotating and also, lateral moveable via bearings in swing arms (10) and (11) in order allow for pressure adjustment for the disc against the ball.

Each swing arm can rotate on input shaft (4) and output shaft (5) respectively.

Each swing arm is provided with gear teeth connected to a positioning controlling gear (12) and (13) respectively.

Input and output shafts (4) and (5) are attached to a gear wheel (6) and (7), which are connected to gear wheel (8) and (9) respectively.

Each gear wheel (12) and (13) are connected to a speed variation common control gear (14) via gears (15) on shafts.

When control gearwheel (14) is rotated the swing arms will rotate to or from each other depending of direction of rotation whilst swing arms simultaneously changing relative position between gear wheel (9) and (7) even whilst rotating.

Drawing 3, indicates various speed configurations when swing arms are moving to and from each other.

### Drawing #3

FIG. 1, indicates swing arms named A and B respectively which on following figures are only indicated as line A or B.

FIG. 2, show swing arm A with the disc in neutral position relative to the ball because the center of the disc corresponds to the center of the ball. When disc on swing arm A rotates the ball will not rotate and thus the disc on swing arm B will not rotate either.

FIG. 3, show swing arm A rotated partly to the left and thus swing arm B rotated partly to the right. The disc on swing arm A causes the ball to rotate and the disc on swing arm B to rotate in the opposite direction at a slower speed than the disc on swing arm A.

FIG. 4, show both discs in same position which will cause the discs to rotate at same speed.

FIG. 5, show a position where the discs center points passed each other and thus disc on swing arm B rotate faster than the disc on swing arm A.

FIG. 6, show a position where the discs are positioned further away from each other from the starting neutral point as per FIG. 2. This will cause disc B to rotate in reverse direction as compared to i.e. FIGS. 3,4 and 5.

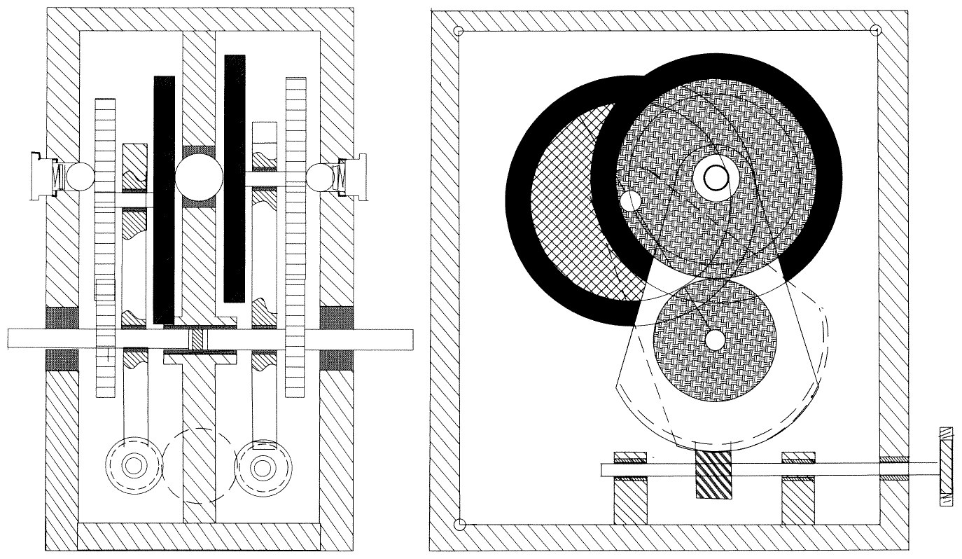

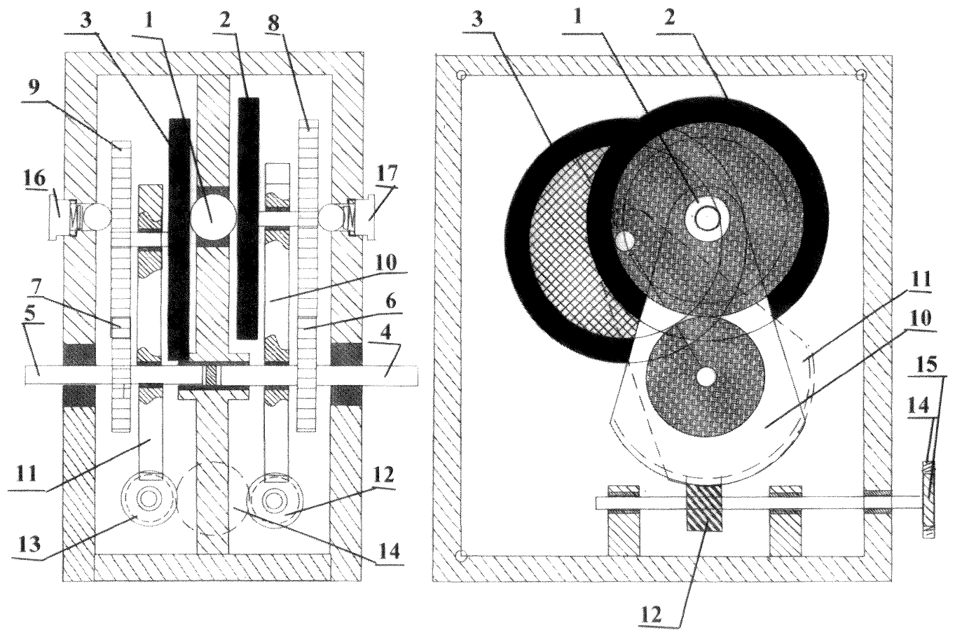

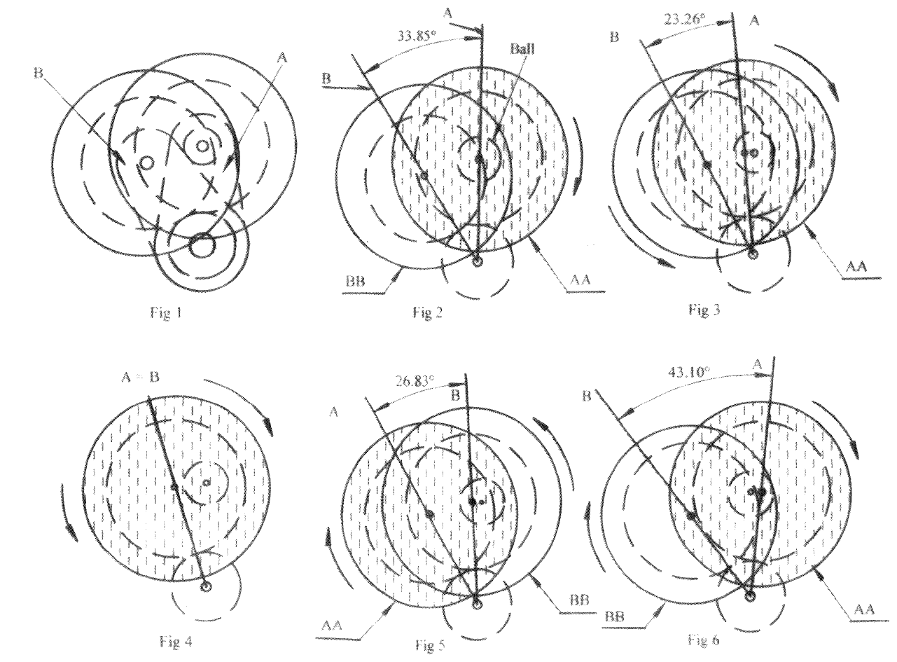

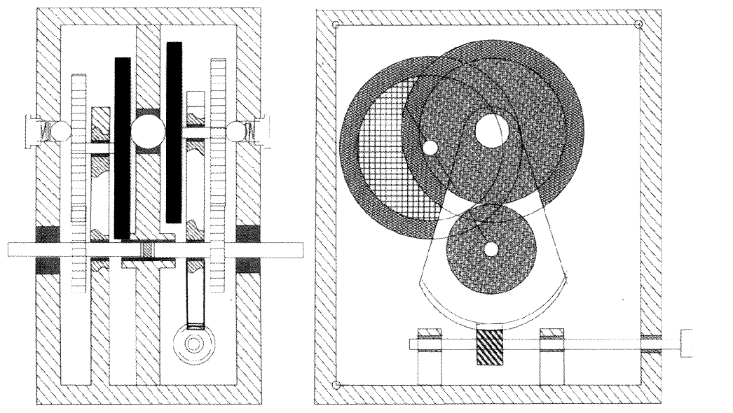

### DRAWING #4

This drawing show the invention with only one swing arm which means that input needed of the speed variation control gear for moving the swing arm is far greater than with two swing arms moving to and from each other for achieving same result.

1. A continuous variable transmission variator where a freely rotatable ball is fixed located between two rotatable flat high friction treated discs and where the discs are fitted on swingarms freely rotating on input and output shaft enabling the discs to move to and from each other thus changing relative position to each other meaning that when one disc center faces center of the ball the other is offset to the center of the ball and whereby each disc are connected to either an input or output shaft freely rotating in each swing arm via wheels connected to wheels fixed to input and output shaft and where the discs fitted on swing arms changes relative position on input and output shafts wheels when swing arms are moved and when the ball is in center position of one disc the other shaft is not rotating and when the position of one of the discs passes above mentioned center point the other disc will rotate in opposite direction in relation to the previous direction.

2. Swing arms as per claim 1 fitted with gear track connected to a gear wheel on a shaft with another gear wheel fitted at the end of shaft and a center controller gear wheel connected to both gear shafts end gears whereby rotating the controller wheel the swing arms will move towards or away from each other depending on if forward neutral or reverse movement desires on the output shaft.

3. A device as per claim 1 fitted with one rotatable wheel with disc in fixed position in relation to the ball and one fitted on a swing arm whereby the rpm variation and neutral and reverse function requires a larger travel for the swing arm in order achieve same function as device according to claim 1.
